(19) United States
(12) Patent Application Publication
(10) Pub. No.: US 2024/0375030 A1
(43) Pub. Date: Nov. 14, 2024

(54) FILTER PURGE AND MAINTENANCE CONTROL SYSTEM

(71) Applicant: Pitco Frialator, Inc., Bow, NH (US)

(72) Inventors: Jared C. Perkins, Chester, NH (US); Matthew Conti, Concord, NH (US); Steven J. Cyr, Bow, NH (US)

(73) Assignee: Pitco Frialator, Inc., Bow, NH (US)

(21) Appl. No.: 18/640,339

(22) Filed: Apr. 19, 2024

Related U.S. Application Data
(60) Provisional application No. 63/501,486, filed on May 11, 2023.

(51) Int. Cl. B01D 35/143; A47J 37/12; B01D 35/02; B01D 35/153; G01N 15/08

(52) U.S. Cl. CPC B01D 35/143; A47J 37/1223; A47J 37/1266; B01D 35/02; B01D 35/153; G01N 15/082; B01D 2201/08; B01D 2201/167; B01D 2201/204; G01N 2015/084

(57) ABSTRACT

A filter purge and maintenance control system monitors a fluid circulation line passing fluid through a filter. The system includes a vacuum switch manifold having a first vacuum switch sensing a first calibrated vacuum threshold, and a second vacuum switch sensing a second calibrated vacuum threshold in the fluid circulation line. The first vacuum switch provides a first calibrated vacuum threshold signal. The second vacuum switch provides a second calibrated vacuum threshold signal. A purge switch is actuated to purge a fluid from a filter housing, and a reset switch is actuated to reset the control system to a filtering operation. A first indicator is connected to the first vacuum switch for receiving the first calibrated vacuum threshold signal and illuminating the first threshold indicator. A second indicator is connected to the second vacuum switch for receiving the second calibrated vacuum threshold signal and illuminating the second threshold indicator.

### CROSS-REFERENCES TO RELATED APPLICATION DATA

This application claims the benefit of U.S. Provisional Patent Application No. 63/501,486 filed May 11, 2023, the contents of which are hereby incorporated by reference in its entirety.

### FIELD OF TECHNOLOGY

The present disclosure relates generally to filtration systems for fluid devices, and to systems for controlling filtration systems.

### BACKGROUND

Fluid systems may involve the circulation of fluid through the system being subject to periodic or continuous filtration. In one example, the use of fluids such as oil in cooking is well known. During the cooking process, the oil may accumulate particles, and that reduces heating efficiency by absorbing some of the heat in the oil instead of allowing the heat to transfer to the food for cooking/heating. Accordingly, it is desirable to periodically reduce accumulation of particulates in the fluid or continuously process the fluid to substantially eliminate accumulation of particulates in the fluid.

It is commonly known to add a filtration mechanism or filter to fluid systems, e.g., cooking systems such as fryers. In such systems, the fluid or oil is pumped or pressurized to move through the filter to remove particulate from the oil. An integrated filter may allow for better fluid control and maintenance, and extend the useful life of the oil. For example, a filter mechanism in a fryer system, may allow the fryer to perform more cooking cycles with the oil by cycling the oil through the filter to clean the oil.

However, previous implementations of filters and filter mechanisms provided limited or no feedback on the state of the filter in operation. Known systems suffered from the drawback of requiring periodic replacement of the filter based on a rigid (frequent or infrequent) schedule of having to bring the fluid system, e.g., fryer, down regardless of and without knowledge of the state of the filter. Ceasing operation of the system in which the filter mechanism resides, in order to change/service the filter, requires the system, e.g., fryer/cooking system, to be offline for service for extended periods, reducing system efficiency and availability.

### SUMMARY

The present disclosure provides a filter purge mechanism and maintenance electrical system that facilitates improved monitoring and accessibility to a filter in a filtration system for efficiently isolating and servicing the filtration system. The filter purge and maintenance control system provides increased filter accessibility for changing the filter, and an electrical monitoring, isolation and control system that facilitates replacing the filter to achieve system maintenance efficiencies.

In one embodiment, a filter purge and maintenance control system includes a filtration media in a filter housing, installed in a device such as a fryer for filtering a fluid such as cooking oil in a fluid circulation line. A check valve may connect a vacuum switch manifold to the fluid circulation line. The vacuum switch manifold monitors a pressure in the fluid circulation line to determine a state of the filtration media. When a first calibrated vacuum threshold is reached, a first vacuum switch may send a signal to illuminate a first indicator. The first calibrated vacuum threshold may be set to a filtration media capacity of approximately 50% capacity (indicating roughly half the flow through the media than when the media is new/fresh). When a second calibrated vacuum threshold is reached, a second vacuum switch may send a signal to illuminate a second indicator. The second vacuum switch may also send a signal to a relay switch for initiating a temporary lockout and turning off a heater of the fryer oil. For example, the second calibrated vacuum threshold may be set to when the filtration media reaches at least 90% capacity.

A purge switch may be connected to the fluid circulation line which, when actuated, purges a fluid from the filter housing in a purge operation. Once the fluid has been purged from the filter housing, the filtration media in the housing may be replaced or otherwise maintained. A reset switch, when actuated, resets the filter purge and maintenance control system. The filter purge and maintenance control system may signal the fryer to re-engage a fluid system pump and resume a filtering operation using the replaced filtration media. The reset switch may end the temporary lockout and re-enable the heater of the fryer oil monitoring and control system to continue heating the fluid.

An illustrative embodiment of the filter purge and maintenance control system may include a tiltable filter canister configured for enclosing the filtration media, such as described in detail in U.S. Patent Application Ser. No. 63/501,451, entitled TILTABLE FILTER CANISTER, filed on May 11, 2023, which is hereby incorporated by reference in its entirety.

In an embodiment, a signal may be sent, e.g., from a switch, signaling that the fluid may be pumped from within the filter canister in a purge operation. A signal to purge the fluid from inside the filter housing may be sent to a pump to pump the fluid from the housing.

Once the purge has been completed, the lid may be removed from the filter housing to provide access to the filtration media. The filtration media may be replaced and/or the filter housing may be otherwise serviced, e.g., the interior of the filter housing may be cleaned, or a blockage in the housing may be cleared, or the like. The lid may be re-placed on the filter housing and the fluid pumped to form the vacuum tight seal between the lid and the filter housing.

By way of example, a fryer is described using an embodiment of the filter purge and maintenance control system. However, a person of ordinary skill in the art would understand that the present disclosure may be adapted for use with various other devices within and outside of the cooking industry. The filter purge and maintenance control system may be used as described with any of various devices requiring the use of a filtration media that requires replacement or service.

The above summary has outlined, rather broadly, some features and advantages of the present disclosure in order that the detailed description that follows may be better understood. Additional features and advantages of the disclosure will be described below. It should be appreciated by those skilled in the art that this disclosure may be readily utilized as a basis for modifying or designing other structures/processes/steps for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization, method of operation, or resultant product, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

Embodiments of devices, systems, and methods are illustrated in the figures of the accompanying drawings which are meant to be exemplary and non-limiting, in which like references are intended to refer to like or corresponding parts, and in which:

FIG. 1A is a schematic diagram of an embodiment of a filter purge and maintenance control system according to the disclosure.

FIG. 1B is a schematic diagram of an embodiment of a vacuum switch manifold of the filter purge and maintenance control system of FIG. 1A.

FIG. 2 is a schematic diagram of a filter purge and maintenance control system circuitry according to the disclosure.

FIG. 3 is a view of an embodiment of a fryer panel and circuitry layout for implementing a filter purge and maintenance control system according to the disclosure.

FIG. 4 is a flow diagram illustrating process monitoring and flow of the filter purge and maintenance control system according to the disclosure.

FIGS. 5A and 5B are an embodiment of a Graphical User Interface for a filter purge and maintenance control system according to the disclosure.

### DETAILED DESCRIPTION

The detailed description of aspects of the present disclosure set forth herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, references to a singular embodiment may include plural embodiments, and references to more than one component may include a singular embodiment.

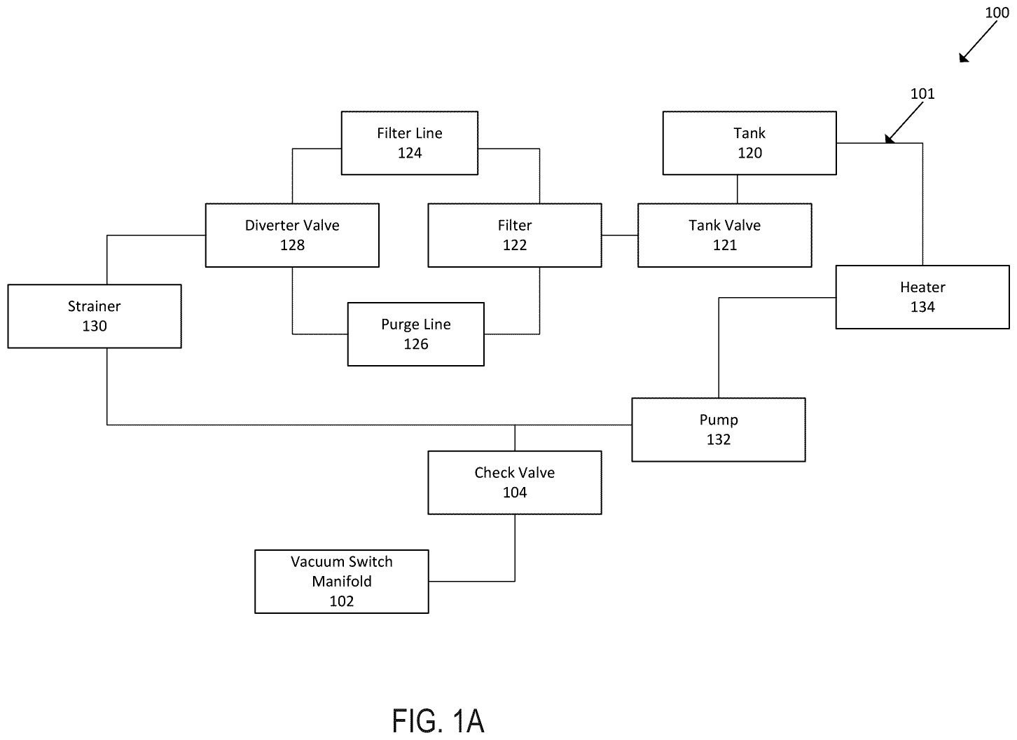

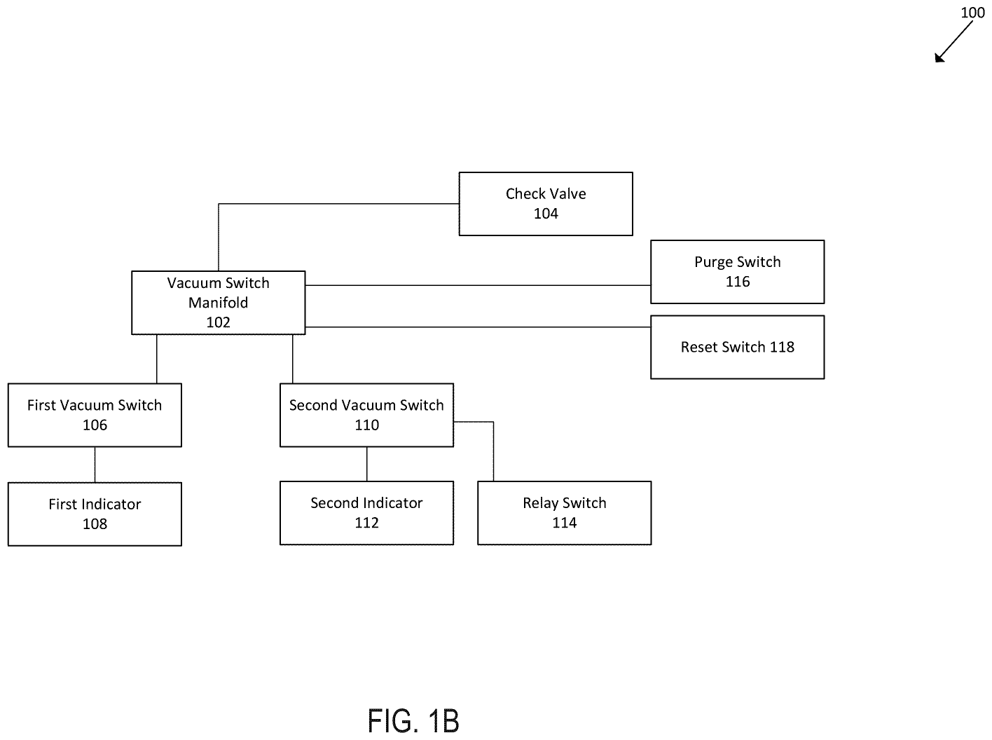

FIG. 1A is a schematic diagram of an embodiment of a filter purge and maintenance control system 100 according to the disclosure. A vacuum switch manifold 102 may be connected to a fluid circulation line 101 for monitoring an inline pressure in the fluid circulation line 101. The vacuum switch manifold 102 may be connected to the fluid circulation line 101 by a check valve 104. The check valve 104 may be a one-way valve to allow a pressure or vacuum force in the fluid circulation line to be measured in the vacuum switch manifold 102 while preventing any fluid flow into the vacuum switch manifold 102. If no pressure or vacuum is applied to the fluid circulation line, the check valve 104 may close to prevent fluid from flowing through the check valve 104 and into the vacuum switch manifold 102.

The fluid circulation line 101 may carry fluid from a tank 120 through a tank valve 121 to a filter 122 including a filter housing enclosing a filtration media. During a filtering operation, the filter 122 may send filtered fluid through a filter line 124 to a diverter valve 128. During a purge operation, the filter 122 may send a purged fluid through a purge line 126 to the diverter valve 128. In an embodiment, the filter line 124 and the purge line 126 may be the same fluid line.

The diverter valve 128 receives the fluid from the filter 122 and may send the fluid to a strainer 130 for filtering. The fluid flows from the strainer 130 to a pump 132. The pump 132 applies pressure or a vacuum to the fluid circulation line 101 of the filter purge and maintenance control system 100. The pump 132 may direct the fluid to a heater 134 before returning the fluid to the tank 120. Although FIG. 1A illustrates the check valve 104 as between the strainer 130 and the pump 132, a person of ordinary skill in the art would understand the check valve 104 may be connected to the fluid circulation line 101 at any of various points to monitor an inline pressure of the fluid circulation line 101 without departing from this disclosure.

FIG. 1B is a schematic diagram of an embodiment of a vacuum switch manifold 102 of the filter purge and maintenance control system 100 of FIG. 1A. The check valve 104 may be connected to the vacuum switch manifold 102 including a first vacuum switch 106 and a second vacuum switch 110. The first vacuum switch 106 and the second vacuum switch 110 may be connected in series in the vacuum switch manifold 102, or in parallel if the vacuum switch manifold 102 is configured with parallel manifolds, to measure pressure in the fluid circulation line 101. If a change in pressure is detected by the first vacuum switch 106 and/or the second vacuum switch 110, it may represent reduced fluid flow in the fluid circulation line 101, indicating blockage(s), i.e., the state of the filter, which at a predetermined threshold will be indicative of the need to replace the filtration media. That is, the vacuum switches effectively monitor the state of the filtration media and indicate when the filtration media's filtering capacity necessitates replacement. The amount of fluid the filtration media can filter before replacement can vary and may depend on, among other things, the type of fluid being filtered, the level of use of the fluid, and the type/quality of the filtration media, among other considerations.

The first vacuum switch 106 may be connected to a first indicator 108. When a first calibrated vacuum threshold is measured in the fluid circulation line 101, the first vacuum switch 106 is actuated or closed. The first vacuum switch 106 may send a first calibrated vacuum threshold signal to illuminate the first indicator 108. The second vacuum switch 110 may be connected to a second indicator 112. When a second calibrated vacuum threshold is measured in the fluid circulation line 101, the second vacuum switch 110 is actuated or closed. The second vacuum switch 110 may send a second calibrated vacuum threshold signal to illuminate the second indicator 112. The first vacuum switch 106 and the second vacuum switch 110 may be connected to the vacuum switch manifold 102 such that only one of the first indicator 108 and the second indicator 112 may be illuminated at a time.

In an embodiment, a relay switch 114 may be connected to the second vacuum switch 110. When the second vacuum switch 110 is actuated, the second calibrated vacuum threshold signal may be sent to the relay switch 114 to institute a temporary lockout and disable the heater 134 of the fryer. A purge switch 116 may be actuated to purge fluid from the filter 122 housing for performing a maintenance operation on the filter (e.g., to change the filter in the system). After the maintenance operation is completed, a reset switch 118 may be actuated to return the filter purge and maintenance control system 100 to an operational mode (e.g., to enable the heater and pump to circulate fluid in the fluid circulation line 101. For example, the reset switch 118 may signal the filter purge and maintenance control system 100 to conduct or resume a filtering operation. The reset switch 118 may send a signal to the vacuum switch manifold to reset the first vacuum switch 106 and the second vacuum switch 110 to an open position.

In an embodiment, a three-pole reset switch 118 may be used to operate the pump 132 and the diverter valve 128 of the filter purge and maintenance control system 100. The three-pole reset switch 118 may include a first position to run the filter purge and maintenance control system 100 in a filtering operation, e.g., wherein the fluid circulates in the fluid circulation line 101 for fryer cooking operation. A second position of the three-pole reset switch 118 may actuate the diverter valve 128 in the fluid circulation line 101, e.g., to switch a polarity of the diverter valve to change the fluid circulation line from flowing through a filter line (such as 124 in FIG. 1A) to a purge line (such as 126 in FIG. 1A). The three-pole reset switch 118 may be set to a third position to operate the pump 132 and purge the fluid from the filter 122 housing.

The filter purge and maintenance control system 100 of FIGS. 1A-1B may be connected to a fryer in an embodiment of the disclosure. As a fluid such as cooking oil is used to fry a food, particulates such as food crumbs may accumulate in the cooking oil. The fryer may include the filter 122 with a filter housing enclosing a filtration media. The filter 122 may be installed inline to the fluid circulation line 101. The filter may send a filtered cooking oil through the filter line 124 to the diverter valve 128. As the filtration media filters the cooking oil, the filtration media may limit flow of oil in the system as particulates accumulate on the filtration media. The particulates removed by the filtration media may slow the flow of fluid through the filter 122 and, as a resulting, change the pressure in the fluid circulation line 101.

The vacuum switch manifold 102 may monitor the pressure of the cooking oil in the fluid circulation line 101 using the check valve 104. When the pressure in the fluid circulation line 101 meets the first calibrated vacuum threshold, the first vacuum switch 106 may actuate to complete a circuit and generate the first calibrated vacuum threshold signal. The first calibrated vacuum threshold signal may illuminate the first indicator 108. The first calibrated vacuum threshold signal may be set to detect pressure that represents approximately 50% of the filtration media's capacity as being exhausted, or a partial clog in the fluid circulation line 101. When the pressure in the fluid circulation line 101 meets the second calibrated vacuum threshold, the second vacuum switch 110 may actuate. The second calibrated vacuum threshold may be set to actuate the second vacuum switch 110 at a pressure representing approximately 90% of the filtration media's capacity as being exhausted (i.e., needing to be replaced) or a clog in the fluid circulation line 101.

The second vacuum switch 110 actuating may generate the second calibrated vacuum threshold signal. The second calibrated vacuum threshold signal may illuminate the second indicator 112. The second vacuum switch 110 may send the second calibrated vacuum threshold signal to the relay switch 114 to initiate the temporary lockout of the fryer. The heater 134 of the fryer may be turned off or disabled as part of the temporary lockout. If the second calibrated vacuum threshold has not been reached but the first calibrated vacuum threshold has, the second indicator will not be illuminated, the temporary lockout may not be initiated and the heater 134 may remain on to continue a filtering/fryer operation.

The filter 122 of the fryer may be located under a top deck (not shown) which may limit access to the filter 122 during the filtering operation of the filter purge and maintenance control system 100. If the temporary lockout has not been initiated, a user may turn off the heater 134 of the fryer. For example, the top deck of the fryer may incorporate a switch so that when the top deck is lifted the switch shuts off the heater 134.

The purge switch 116 may be operated to stop flow of the fluid from the tank 120 to the filter 122 by closing the tank valve 121 between the tank 120 and the filter 122. The diverter valve 128 may be operated to change the fluid circulation line 101 from flowing through the filter line 124 to flowing through the purge line 126. With the oil flow diverted, the filter housing of the filter 122 may be opened to break a vacuum seal of the filter 122. In an embodiment, the filter housing may be opened and exposed to atmosphere to prevent creating a vacuum inside the filter housing during a purge operation. With the vacuum seal broken, the purge switch 116 may be operated to activate the pump 132 and purge the oil from the filter housing through the purge line 126 to the diverter valve 128. As the oil is purged from the filter housing, it may be temporarily replaced by air. The oil may flow through the purge line 126 and the diverter valve 128 to a strainer 130 before moving through the pump 132 and heater 134 to return to the tank 120.

A maintenance operation such as replacing the filtration media or cleaning the interior of the filter housing may take place before closing the filter housing and reforming the vacuum seal of the filter 122. The reset switch 118 may be operated to reset the filter purge and maintenance control system 100 to an operational mode or filtering operation. The first vacuum switch 106 and the second vacuum switch 110 may be reset to turn off the illumination of the first indicator 108 and the second indicator 112 respectively. The diverter valve 128 may be operated to change the fluid circulation line 101 from flowing through the purge line 126 to flowing through the filter line 124. The relay switch 114 may be reset to end the temporary lockout and turn on the heater 134. The filtering operation may resume and the filter purge and maintenance control system 100 may resume monitoring the pressure in the fluid circulation line 101.

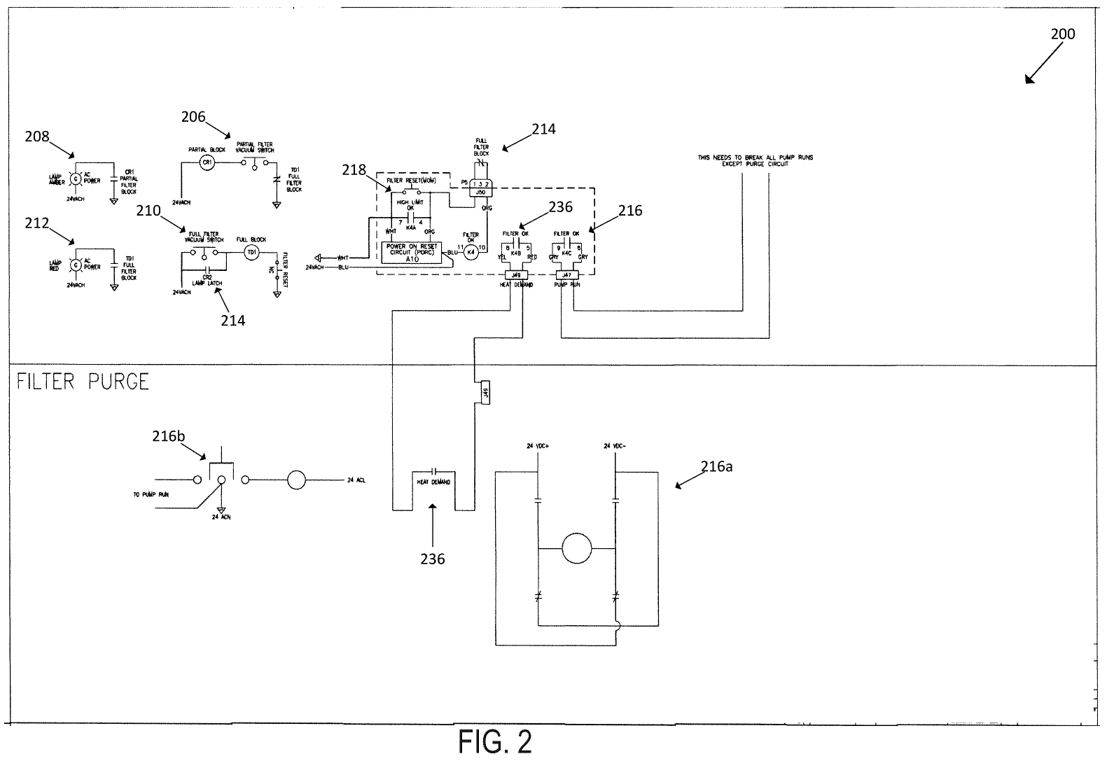

FIG. 2 is a schematic diagram of electrical components of filter purge and maintenance control circuitry 200 according to the disclosure. The filter purge and maintenance control circuitry 200 may include a first vacuum switch 206 connected to a first indicator 208 for indicating a partial block in a fluid circulation line. As the filtration media filters the fluid/oil, the filtration media accumulates particulate, such as food crumbs, causing a change in the inline pressure of the fluid circulation line. The change in pressure may cause the first vacuum switch 206 to actuate, completing a circuit and illuminating the first indicator 208 indicating a level of accumulated particulate. The first vacuum switch 206 may be configured to actuate at a first calibrated vacuum threshold indicating the filtration media has reached approximately 50% capacity of accumulated particulate.

A second vacuum switch 210 may be connected to a second indicator 212. The second vacuum switch 210 may be configured to actuate when the filtration media has reached at least 90% capacity. The second vacuum switch 210 actuating completes a circuit and illuminates the second indicator 212. The second vacuum switch 210 may cause a relay switch 214 to institute a temporary lockout. During the temporary lockout, the heat demand switch 236 may turn off a heater (such as 134 in FIG. 1A).

A purge switch 216 may be operated to run a purge operation. In an embodiment of the filter purge and maintenance control system circuitry 200, the purge switch 216 may be a three-pole relay switch. The three-pole relay switch may include a first position for running a filtering operation, a second position for operating a diverter valve, and a third position for running a purge operation. The purge switch 216 in the first position may run a filtering operation such as described with respect to FIG. 1A. The second position of the purge switch 216 may operate a valve circuit 216a to switch a polarity of a diverter valve (such as 128 in FIG. 1A) to change the fluid circulation line from flowing through a filter line (such as 124 in FIG. 1A) to a purge line (such as 126 in FIG. 1A). The third position of the purge switch 216 may operate a pump circuit 216b to run a pump (such as 132 in FIG. 1A) to purge a fluid from a filter housing, as described with respect to FIGS. 1A-1B.

A reset switch 218 may be operated to reset the filter purge and maintenance control system circuitry 200. The reset switch 218 may communicate with the purge switch 216 to operate the valve circuit 216a to reset the polarity of the diverter valve to change the fluid circulation line from flowing through the purge line (such as 126 in FIG. 1A) to the filter line (such as 124 in FIG. 1A). The reset switch 218 may reset the heat demand switch 236 to turn on the heater (such as 134 in FIG. 1A) and end the temporary lockout. With the reset of the filter purge and maintenance control system circuitry 200, a filtering operation may begin or resume such as the filtering operation described with respect to FIG. 1A.

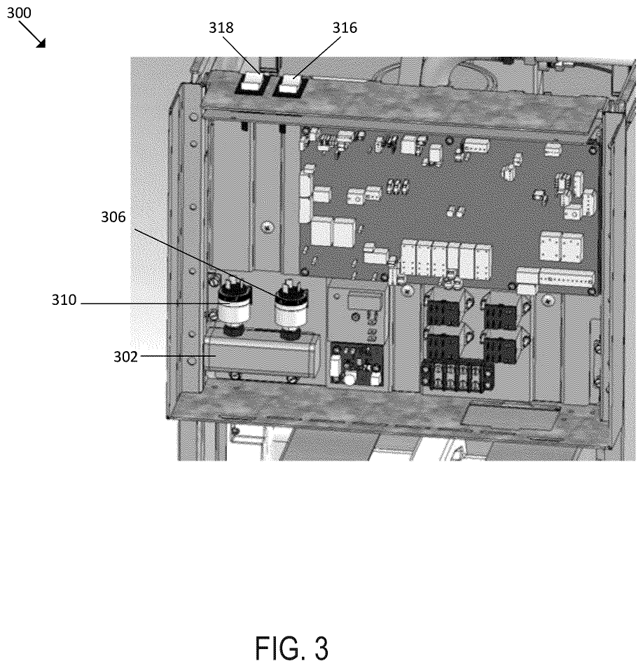

FIG. 3 is a view of an embodiment of a fryer panel and circuitry layout for implementing a filter purge and maintenance control system 300 according to the disclosure. A vacuum switch manifold 302 may include a first vacuum switch 306 and a second vacuum switch 310 connected to the filter purge and maintenance control system 300 for monitoring pressure in a fluid circulation line. When the pressure in the fluid circulation line reaches a first calibrated vacuum threshold, the first vacuum switch 306 may actuate. When the pressure in the fluid circulation line reaches a second calibrated vacuum threshold, the second vacuum switch 310 may actuate and cause the filter purge and maintenance control system 300 to initiate a temporary lockout. In an embodiment, the first calibrated vacuum threshold may actuate the first vacuum switch 306 when a filtration media in the filter housing reaches approximately 50% capacity. The second calibrated vacuum threshold may actuate the second vacuum switch 310 when the filtration media reaches at least 90% capacity.

A purge switch 316 may be operated to purge fluid from a filter housing connected to the filter purge and maintenance control system 300, as described hereinbefore. Once the fluid is purged, a maintenance operation may take place to address the cause of the fluid circulation line reaching the first or second calibrated vacuum threshold. For example, the maintenance operation may include replacing the filtration media or cleaning an interior of the filter housing.

A reset switch 318 may be operated to reset the filter purge and maintenance control system 300, as described hereinbefore. The reset may include resetting the first vacuum switch 306 and second vacuum switch 310 to be in an open position. The temporary lockout may be disabled and the filter purge and maintenance control system 300 may resume an operational mode such as a filtering operation, as described hereinbefore.

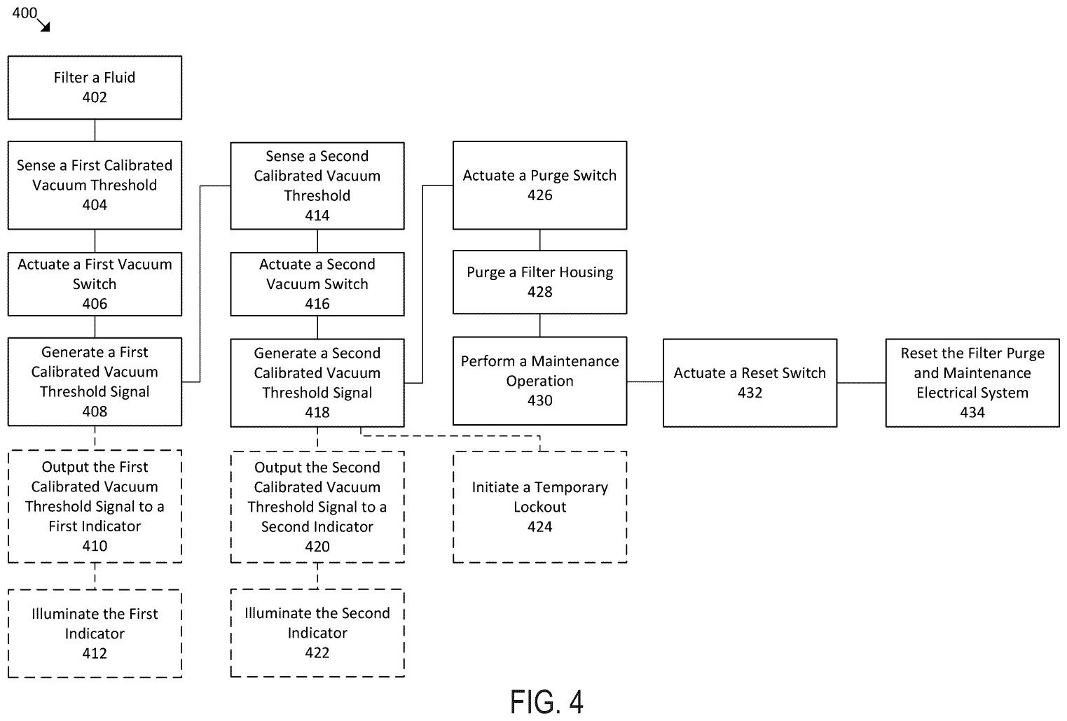

FIG. 4 is a flow diagram illustrating process monitoring and flow of the filter purge and maintenance control system 400 according to the disclosure. In an embodiment, the filter purge and maintenance control system 400 may be installed in a cooking implement, such as a fryer. A filtration media of the fryer may filter 402 a fluid such as cooking oil in a fluid circulation line. The fluid circulation line may be monitored to determine a state (e.g., level of particulates) of a filtration media. The state of the filtration media may include determining when the filtration media has accumulated particulates to a level that warrants replacement of the filtration media, or if a clog in the fluid circulation line has formed. A vacuum switch manifold (such as 102 in FIGS. 1A-1B) may sense when a first calibrated vacuum threshold is reached in the fluid circulation line 404. The pressure in the fluid circulation line may actuate a first vacuum switch 406 and generate a first calibrated vacuum threshold signal 408. The first calibrated vacuum threshold signal may be output to a first indicator 410 causing the first indicator to illuminate 412.

The vacuum switch manifold may sense when a second calibrated vacuum threshold is reached in the fluid circulation line 414. The pressure in the fluid circulation line may actuate a second vacuum switch 416 and generate a second calibrated vacuum threshold signal 418. The second calibrated vacuum threshold signal may be output to a second indicator 420 causing the second indicator to illuminate 422. The second calibrated vacuum threshold signal may initiate a temporary lockout 424 of the filter purge and maintenance control system 400, e.g., to lockout various functions of the system such as heating and/or fluid circulation.

A purge switch may be actuated 426 to initiate a purge operation. A filter housing enclosing the filtration media may be purged of the fluid to enable access to the filtration media 428. A maintenance operation 430 may be performed on the filter purge and maintenance control system 400 to replace the filtration media or clear a clog in the filtration media. A reset switch may be actuated 432 to reset 434 the filter purge and maintenance control system 400, and/or to reset other system controls such as heating and/or fluid circulation.

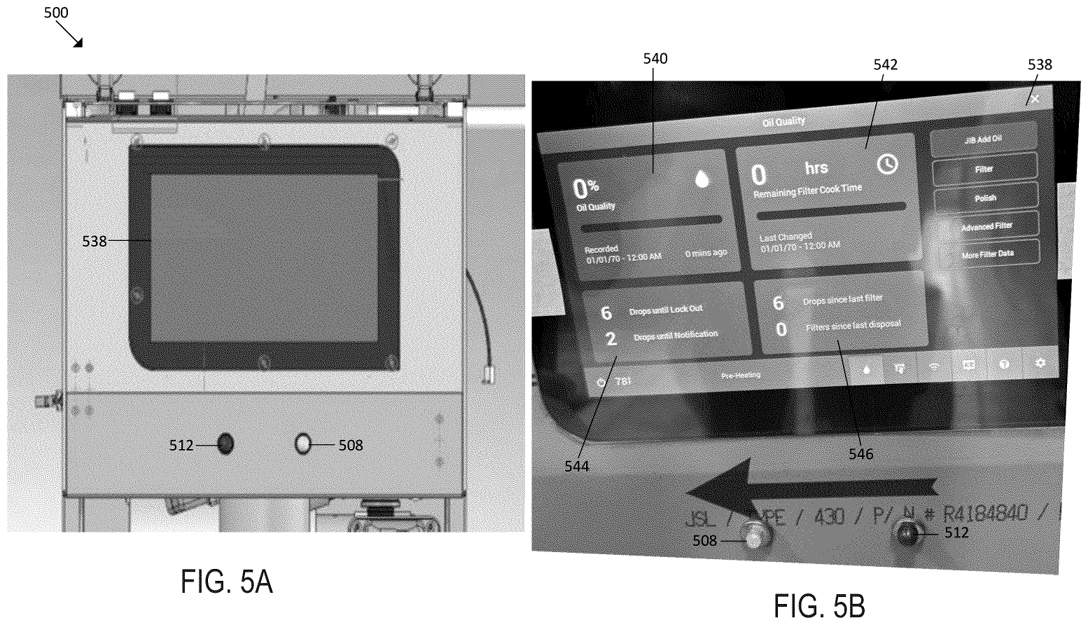

By way of example, the illumination of the first or second indicator may cause an operator to actuate the purge switch 426. The operator may physically actuate 426 the purge switch or send a signal to actuate 426 the purge switch using a Graphical User Interface such as a Graphical User Interface illustrated in FIGS. 5A-5B. Similarly, the operator may physically actuate 432 the reset switch or send a signal to actuate 432 the reset switch using a Graphical User Interface such as the Graphical User Interface of FIGS. 5A-5B.

FIG. 5A illustrates an embodiment of a Graphical User Interface 500 for a filter purge and maintenance control system according to the disclosure. A first indicator 508 may illuminate to indicate a first calibrated vacuum threshold has been reached in a fluid circulation line. A second indicator 512 may illuminate to indicate a second calibrated vacuum threshold has been reached in the fluid circulation line. An alert may be displayed on a screen 538 of the Graphical User Interface 500 regarding a status of a filtration media connected to the filter purge and maintenance control system.

FIG. 5B illustrates a further embodiment of the Graphical User Interface 500 according to the disclosure. The screen 538 may include a first display 540 to indicate a sensed oil quality and whether a fluid such as cooking oil needs to be replaced. A second display 542 may indicate the estimated remaining time to complete a task such as cooking a food in a fryer. A third display 544 may indicate the status of an inline pressure of the fluid circulation line and how many times a vacuum switch manifold (such as 102 in FIGS. 1A-1B) can record a pressure drop before a temporary lockout as described hereinbefore may be instituted. A fourth display 546 may include a filter tracker for tracking the status of the filtration media by indicating how many filtration media have been consumed with the current fluid in the filter purge and maintenance control system and how many pressure drops have occurred in the fluid circulation line since the filtration media was last replaced. The Graphical User Interface 500 assists a user in verifying a status of the filter purge and maintenance control system at a glance. In an embodiment of the Graphical User Interface 500, the screen 538 may be a touchscreen to enable the user to quickly navigate the various alerts and displays indicating the status of the filter purge and maintenance control system.

Although indicators are described herein as illuminating at particulate levels of 50% and 90% of particulate capacity on the filter, it should be appreciated that threshold levels may be established to illuminate indicators at levels other than 50% and 90%. For example, indicators could be illuminated at 30%, 40% and/or 50% as first indicator levels, and/or at 70%, 80% or 90% as the second indicator threshold levels, any of various levels in between, above or below such levels. Further, it should be appreciated that ranges of filter particulate levels may be implemented without departing from the spirit or scope of the disclosure.

Further, although indicators are described herein as indicators that illuminate, it should be appreciated by those skilled in the art that any of various indicators could be implemented, such as gauges, pictographs, LED bars, audible indicators of various sorts, and indicators implemented on Graphical User Interface displays, or the like.

It should be understood that when an element is referred to as being “connected” or “coupled” to another element (or variations thereof), it can be directly connected or coupled to the other element or intervening elements may be present. In contrast, when an element is referred to as being “directly connected” or “directly coupled” to another element (or variations thereof), there are no intervening elements present.

Benefits, other advantages, and solutions to problems have been described herein with regard to specific embodiments. However, the benefits, advantages, solutions to problems, and elements that may cause any benefit, advantage, or solution to occur or become more pronounced are not to be construed as critical, required, or essential features or elements of the disclosure. It should be appreciated that in the appended claims, reference to an element in the singular is not intended to mean “one and only one” unless explicitly so stated, but rather “one or more.”

Embodiments of the present disclosure are described herein with reference to the accompanying drawings. However, the present disclosure should not be construed as limited to the embodiments set forth herein. Rather, these embodiments are provided so that this disclosure will be thorough and complete, and will fully convey the scope of the present disclosure to those skilled in the art. As used herein, the singular forms “a,” “an,” and “the” are intended to include the plural forms as well, unless the context clearly indicates otherwise. It will be further understood that the terms “comprises,” “comprising,” “having,” “includes,” “including,” and/or variations thereof, when used herein, specify the presence of stated features, steps, operations, elements, and/or components, but do not preclude the presence or addition of one or more other features, steps, operations, elements, components, and/or groups thereof.

Although illustrative embodiments of the present disclosure have been described herein with reference to the accompanying drawings, it is to be understood that the present disclosure is not limited to those precise embodiments, and that various other changes and modifications may be made by one skilled in the art without departing from the scope or spirit of the disclosure.

What is claimed is:

1. A filter purge and maintenance control system, comprising:
a filter in a filter housing, the filter filtering a fluid in a fluid circulation line;
a vacuum switch manifold including a first vacuum switch and a second vacuum switch;
the first vacuum switch sensing a first calibrated vacuum threshold in the fluid circulation line, the first vacuum switch actuating upon a first calibrated vacuum threshold being reached and providing a first calibrated vacuum threshold signal;
the second vacuum switch sensing a second calibrated vacuum threshold in the fluid circulation line, the second vacuum switch actuating upon a second calibrated vacuum threshold being reached and providing a second calibrated vacuum threshold signal;
a purge switch, actuated to purge the fluid from the filter housing;
a reset switch, actuated to reset the filter purge and maintenance control system to a filtering operation;
a first indicator connected to the first vacuum switch for receiving the first calibrated vacuum threshold signal; and
a second indicator connected to the second vacuum switch for receiving the second calibrated vacuum threshold signal.

2. The filter purge and maintenance control system of claim 1, wherein the second vacuum switch outputs the second calibrated vacuum threshold signal to a relay switch for initiating a temporary lockout.

3. The filter purge and maintenance control system of claim 1, wherein the first calibrated vacuum threshold is determined by a pressure in the fluid circulation line indicating the filter is at approximately 50% capacity.

4. The filter purge and maintenance control system of claim 1, wherein the second calibrated vacuum threshold is determined by a pressure in the fluid circulation line indicating the filter has reached at least 90% capacity.

5. The filter purge and maintenance control system of claim 1, wherein the purge switch is a three-pole relay switch including:
a first position for operating a fryer in a filtering operation;
a second position for actuating a diverter valve in the fluid circulation line; and
a third position for operating the fryer in a purge operation.

6. The filter purge and maintenance control system of claim 1, wherein the first vacuum switch and the second vacuum switch are connected to the filter purge and maintenance control system in series.

7. The filter purge and maintenance control system of claim 1, wherein the first vacuum switch and the second vacuum switch are connected to the filter purge and maintenance control system in parallel.

8. The filter purge and maintenance control system of claim 1, further comprising a check valve connecting the vacuum switch manifold to the fluid circulation line.

9. A filter purge and maintenance system control system, comprising:
a filter in a filter housing, the filter filtering a fluid in a fluid circulation line from a tank;
a diverter valve connected to the filter housing and in line with the fluid circulation line; the diverter valve actuated between a first position and a second position;
a purge switch connected to the diverter valve, the purge switch actuating the diverter valve between the first position and the second position;
a vacuum switch manifold connected to the fluid circulation line;
the vacuum switch manifold comprising a first vacuum switch and a second vacuum switch for monitoring a status of the fluid in the fluid circulation line, the first vacuum switch indicating a first calibrated vacuum threshold is reached in the fluid circulation line and the second vacuum switch indicating a second calibrated vacuum threshold is reached in the fluid circulation line;
a pump connected to the fluid circulation line, the pump applying a pressure to the fluid circulation line; and
a heater connected to the fluid circulation line, the heater controlling a temperature of the fluid in the fluid circulation line.

10. The filter purge and maintenance control system of claim 9, wherein the first vacuum switch outputs a first calibrated vacuum threshold signal to illuminate a first indicator to indicate that the first calibrated vacuum threshold has been reached in the fluid circulation line and the second vacuum switch outputs a second calibrated vacuum threshold signal to illuminate a second indicator to indicate that the second calibrated vacuum threshold has been reached in the fluid circulation line.

11. The filter purge and maintenance control system of claim 9, wherein the second vacuum switch outputs a second calibrated vacuum threshold signal to a relay switch for initiating a temporary lockout.

12. The filter purge and maintenance control system of claim 9, wherein the first calibrated vacuum threshold is determined by a pressure in the fluid circulation line indicating the filter is at approximately 50% capacity.

13. The filter purge and maintenance control system of claim 9, wherein the second calibrated vacuum threshold is determined by a pressure in the fluid circulation line indicating the filter has reached at least 90% capacity.

14. The filter purge and maintenance control system of claim 9, wherein the purge switch is a three-pole relay switch including:
a first position for operating a fryer in a filtering operation;
a second position for actuating the diverter valve in the fluid circulation line; and
a third position for operating the fryer in a purge operation.

15. The filter purge and maintenance control system of claim 9, wherein the first vacuum switch and the second vacuum switch are connected to the filter purge and maintenance control system in series.

16. The filter purge and maintenance control system of claim 9, wherein the first vacuum switch and the second vacuum switch are connected to the filter purge and maintenance control system in parallel.

17. The filter purge and maintenance control system of claim 9, further comprising a check valve connecting the vacuum switch manifold to the fluid circulation line.

18. A method of monitoring and controlling a fluid flow in a filter purge and maintenance control system, comprising:
filtering a fluid through a filtration media in a fluid circulation line;
monitoring a state of the filtration media using a vacuum switch manifold connected to the fluid circulation line by a check valve;
sensing a first calibrated vacuum threshold in the fluid circulation line using a first vacuum switch of the vacuum switch manifold;
outputting a first calibrated vacuum threshold signal from the first vacuum switch and illuminating a first indicator when the first calibrated vacuum threshold is reached;
sensing a second calibrated vacuum threshold in the fluid circulation line using a second vacuum switch of the vacuum switch manifold; and
outputting a second calibrated vacuum threshold signal from the second vacuum switch and illuminating a second indicator when the second calibrated vacuum threshold is reached and initiating a temporary lockout of the filter purge and maintenance control system.

19. The method of monitoring and controlling the fluid flow in the filter purge and maintenance control system of claim 18, further comprising:
turning off a heater connected to the filter purge and maintenance control system;
performing a maintenance operation on the filtration media in the fluid circulation line;
ending the temporary lockout of the filter purge and maintenance control system; and
resuming filtering the fluid through the filtration media in the fluid circulation line.

20. The method of monitoring and controlling the fluid flow in the filter purge and maintenance control system of claim 18, further comprising purging the fluid from the filtration media in the fluid circulation line by actuating a diverting valve and activating a pump connected to the fluid circulation line.
